(19) United States
(12) Patent Application Publication
(10) Pub. No.: US 2015/0063554 A1
(43) Pub. Date: Mar. 5, 2015

(54) TELEPHONE DEVICE AND METHOD FOR AUTO TRANSFERRING INCOMING CALLS

(71) Applicant: HON HAI PRECISION INDUSTRY CO., LTD., New Taipei (TW)

(72) Inventors: JU-CHUN HSIAO, New Taipei (TW); CHENG-CHIEH YANG, New Taipei (TW)

(21) Appl. No.: 14/467,953

(22) Filed: Aug. 25, 2014

(30) Foreign Application Priority Data
Aug. 29, 2013 (TW) 102130972

(51) Int. Cl. H04M 3/54

(52) U.S. Cl. CPC H04M 3/54
USPC 379/211.02

(57) ABSTRACT

A number of telephone devices relating to one user establish a communication connection with a server and receive rules for answering and usage information from the server. The server sequence the plurality of other telephone devices for call forwarding according to the rules for answering and usage information, and transfers an incoming call to one then another telephone device according to a sequencing.

### BACKGROUND

1. Technical Field

The present disclosure generally relates to communications.

2. Description of Related Art

Telephone devices such as home phones, office phones, and mobile phones are ubiquitous at work and in life. Multiple phone numbers are used. A dialed phone number is often not answered and the user needs to cut off and dial another number.

### BRIEF DESCRIPTION OF THE DRAWINGS

FIG. 1 is a schematic diagram of an example environment of the devices of the present disclosure.

FIG. 2 is a block diagram of one embodiment of the devices.

FIG. 3 is a block diagram of another embodiment of the devices.

FIG. 4 is a schematic diagram illustrating an example communication between the server and the telephone devices.

FIG. 5 is a schematic diagram illustrating an example interface after the mobile phone accesses the server.

FIG. 6 is a schematic diagram illustrating an example synchronization of usage information.

FIG. 7 is a flowchart of one embodiment of a method for automatically transferring incoming calls.

FIG. 8 is a flowchart illustrating one embodiment of the transferring of an incoming call.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module” as used hereinafter, refers to logic embodied in hardware or firmware, or to a collection of software instructions, written in a programming language, such as, for example, Java, C, or assembly. One or more software instructions in the modules may be embedded in firmware such as in an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

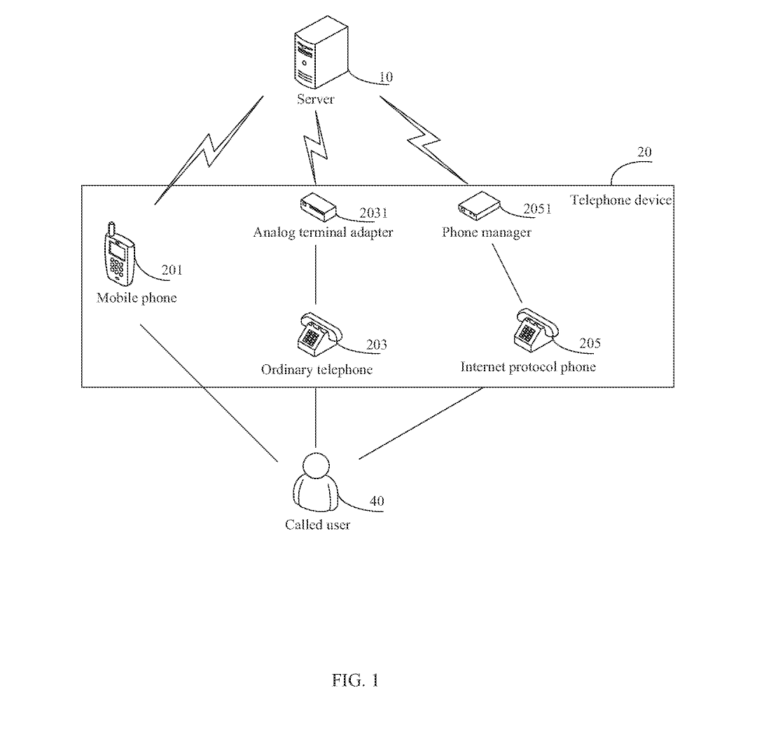

FIG. 1 is a diagram of the environment of the telephone device 20 of the present disclosure. In one embodiment, the called user 40 has a plurality of telephone devices 20 which are all connected with the server 10. When one of the telephone devices 20 has been called (such as an ordinary telephone 203), the call is transferred to the other telephone devices (such as a mobile phone 201) which the called user 40 is able to answer.

In one embodiment, the server 10 may be a computer, the telephone device 20 may be mobile phone 201.

In another embodiment, the telephone device 20 may be an ordinary telephone 203 connected with a analog terminal adapter 2031. The ordinary telephone 203 can first connect with the analog terminal adapter 2031, and then access the server 10. In other embodiment, the ordinary telephone 203 and the analog terminal adapter 2031 may be integrated in a single device.

In other embodiment, the telephone device 20 may be an internet protocol phone 205 with a phone manager 2051. The internet protocol phone 205 can first connect with the phone manager 2051, and then access the server 10. In other embodiment, the internet protocol phone 205 and the phone manager 2051 may be integrated in a single device.

It should be noted that the amount of the called user 40 connected to the server 10 may be more than one, and the amount of the telephone devices 20 of each called user 40 may be more than one. The telephone devices 20 able to access the server may also be other types, the present disclosure is not limited to one type.

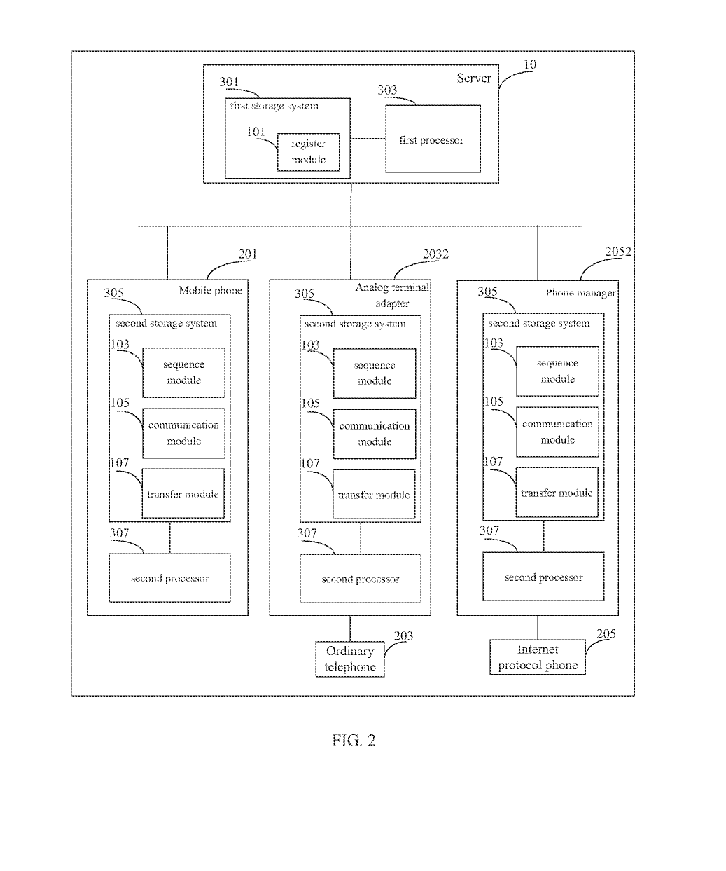

FIG. 2 is a block diagram of one embodiment of the devices. In one embodiment, the server 10 includes a register module 101, a first storage system 301, and a first processor 303. The module 101 can include computerized code in the form of one or more programs. The one or more programs are stored in the first storage system 301, and the first storage system 301 is a non-transitory storage device. The computerized code includes instructions executed by the first processor 303 to provide functions for the modules 101. The devices all include a sequence module 103, a communication module 105, a transfer module 107, a second storage system 305, and a second processor 307. The modules 103-107 may include computerized code in the form of one or more programs. The one or more programs are stored in the second storage system 305, and the second storage system 305 is a non-transitory storage device. The computerized code includes instructions executed by the second processor 307 to provide functions for the modules 103-107. For instance, appropriate applications can be installed in the mobile phone 211 to achieve the functions of the modules 103-107, appropriate applications can be installed in the ordinary telephone 203 on the analog terminal adapter 2031 to achieve the functions, and appropriate applications can be installed in the internet protocol phone 205 on the phone manager 2051 to achieve the functions. In other embodiment, the modules 103-107 can be in the ordinary telephone 203 and the internet protocol phone 205, the present disclosure is not limited to the current embodiment.

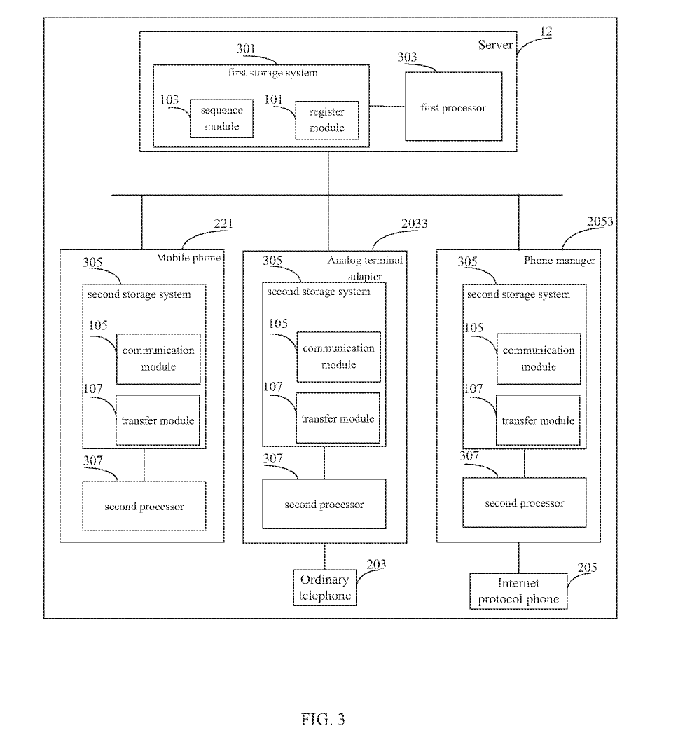

FIG. 3 is a block diagram of another embodiment of the devices. In this embodiment the sequence module 103 is located at the server 11.

Referring to FIG. 2 and the mobile phone 210, the functions of the sequence module 103, the communication module 105, and the transfer module 107 are illustrated.

In one embodiment, the communication module 105 communicates with the server 10 and receives rules for answering and usage information of all the devices from the server 10. Once the mobile phone 201 has connected to the server 10, the communication module 105 registers information of the mobile phone 201 in the register module 101. When the mobile phone 201 has made a phone call, the communication module 105 updates the usage information of the telephone device to the server 10. The communication module 105 also receives usage information of other telephone devices sent by the register module 101.

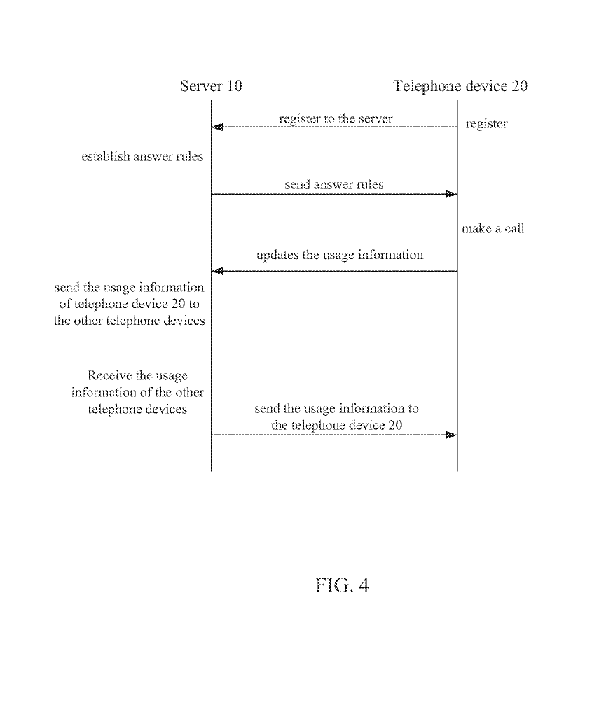

FIG. 4 is a schematic diagram illustrating an example communication between the server 10 and the telephone devices 20. The called user 40 can access the server 10 by username and password, and the server 10 can store the information and connection statuses of the called user's telephone devices. The communication module 105 connects to the register module 101 by inputting the username and password, then the communication module 105 sends the registration information of the mobile phone 201 to the register module 101, wherein the registration information comprises the phone number of the mobile phone 201. The register module 101 receives the registration information and updates the connection status of the mobile phone 201 to “connected”. The register module 101 also sends the respective connection statuses of the other telephone devices to the communication module 105. The connection status indicates whether the telephone device is connected with the server, includes either “connected” or “not connected”. The status of “connected” indicates that the telephone device can communicate with the server properly.

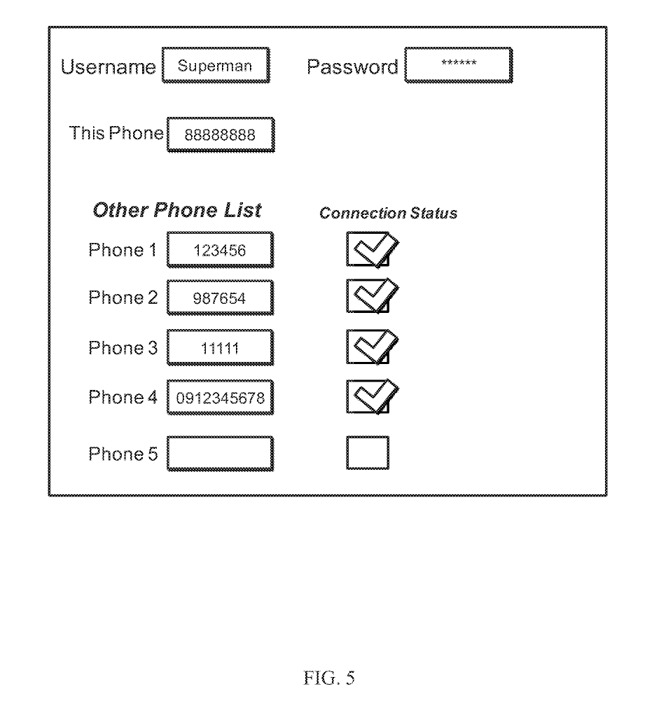

FIG. 5 is a schematic diagram illustrating an example interface after the mobile phone 201 accesses the server 10. For example, the user “superman” has stored a plurality of telephone numbers in the server 10, the number of the mobile phone 201 is “this phone 88888888”, and the “other phone list” shows the telephone numbers and connection statuses of the other telephone devices “telephone 1-4” belonging to the user “superman.”

In one embodiment, the register module 101 of the server 10 sets the rules for answering of all the telephone devices of the called user 40, wherein different telephone devices at different times may have priority. All such rules for answering may be set by the called user 40. For instance, the answer rules may be set in the following ways: during weekday working hours, the sequence of priorities can be: Office Phone first, Mobile Phone second, Home phone third; in the evening, the sequence of priorities can be: Home Phone first, Mobile Phone second, Office phone third. On weekends and during holidays, the sequence of priorities can be: Mobile phone first, Home Phone second, Office phone third. The rules for answering may be set in other manner, the present invention is not limited to the manner of this disclosure.

In one embodiment, the register module 101 sends the answer rules to the communication module 105 of the telephone devices 20 which has a “connected” status. The communication module 105 of the mobile phone 201 receives the answer rules, and makes the mobile phone 201 ready in accordance with the answer rules.

In one embodiment, when there is an incoming call, the communication module 105 of the mobile phone 201 transfers the call to the telephone device with a higher or the highest priority in accordance with the priority sequence in the answer rules. When the mobile phone 201 is the telephone device with highest priority, the mobile phone 201 answers the call, and the communication module 105 updates the usage information to the register module 101 when the call is completed. The usage information comprises the beginning time of the call, the duration, and other information that indicate the usage status after the call. In addition, when the mobile phone 201 makes a call, the communication module 105 also updates the usage information to the register module 101.

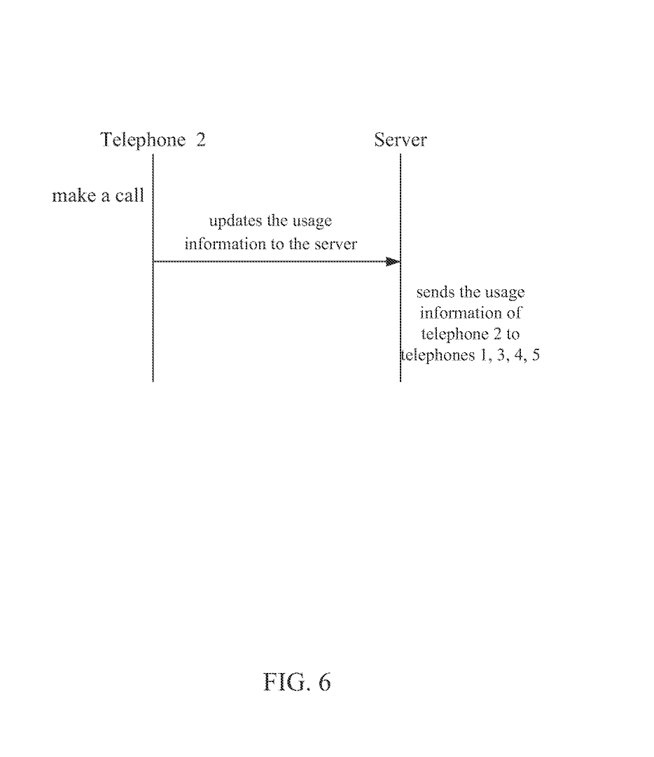

In one embodiment, the register module 101 sends the usage information to the other telephone devices after receiving the usage information sent by the mobile phone 201. FIG. 6 is a schematic diagram illustrating an example synchronization of usage information. In FIG. 6, after the telephone device 2 has made a call, the telephone device updates the usage information to the server, the server receives the information and transfers the information to the other telephones 1, 3, 4, 5. In this embodiment, all the telephone devices 20 connected with the server 10 will update the server 10 with their usage information after answering or making a call. The server 10 synchronizes the usage information to the other telephone devices. In other embodiment, the server 10 may also send the usage information to all of the telephone devices 20.

In one embodiment, the sequence module 103 calculates a sequence according to the usage information of all the telephone devices. The sequence module 103 selects the telephone devices which are “connected,” sorts them in sequence according to their last call time, and sets the telephone device having the most recent call in first place, wherein first place has the highest priority in the sequence. For instance, the current time is 15:53, the last call time of the mobile phone 201 was 15:30, the last call time of the ordinary telephone 203 was 10:29, and the last call time of the internet protocol telephone 205 was 12:07. Therefore, the mobile phone will be set in first place for priority purposes since it had the most recent call. In other embodiment, the sequence module 103 also can give first place to the telephone device having the most recent call within a preset time period. For instance, the preset time period can be half an hour, and when there is an telephone device having a call in the last half an hour, the sequence module 103 sets that telephone device in first place.

The sequence module 103 can sequence the plurality of other telephone devices for call forwarding according to the answer rules and the usage information, and the sequence module 103 updates the sequence for transference in real time based on the usage information. For instance, in the current time, the answer rules of the telephone devices are: telephone 1 first, telephone 2 second, telephone 3 third, telephone 4 fourth, telephone 5 fifth. If the telephone 2 is the telephone device having the most recent call, then the telephone 2 will be set in first place, and the transferring sequence will be: telephone 2 first, telephone 1 second, telephone 3 third, telephone 4 fourth, telephone 5 fifth. Since all of the telephone devices receive the same answer rules and usage information from the server, the transferring sequence calculated by the sequence modules 103 of all the telephone devices will be the same.

In one embodiment, when the mobile phone 201 has been called, the transfer module 107 will transfer the incoming call to a particular one of the plurality of other telephone devices according to a sequencing. As part of the transfer function, the transfer module 107 also determines whether the current destination telephone answers the call within a certain time. The transfer module transfers the call to one of the other telephone devices, based on the current order, upon condition that the telephone device having first place in the sequence has failed to answer the call within a certain time. If none of the telephone devices answer the call, the transfer module 107 can return a voice signal to the caller, such as “the user is busy, please dial again later”, and the transfer module 107 can also record the caller's telephone number.

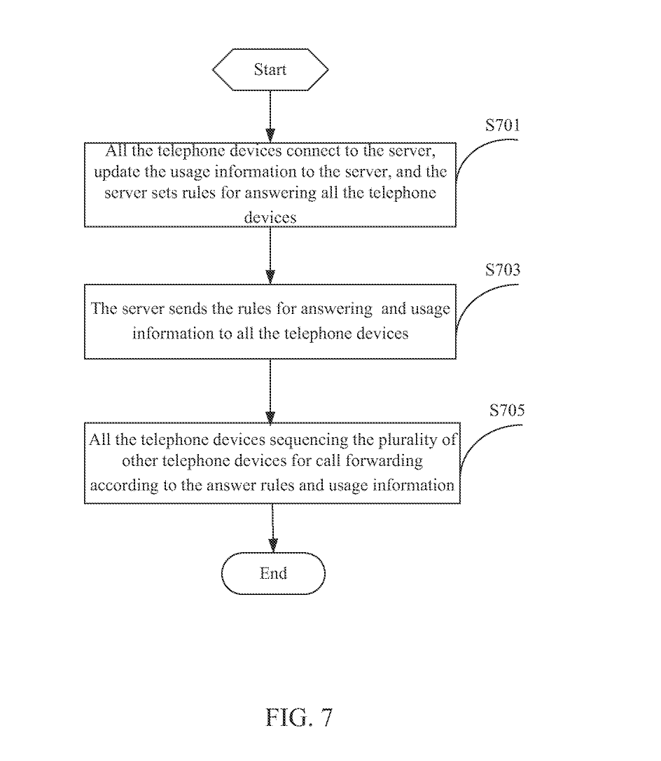

FIG. 7 is a flowchart of one embodiment of a method for automatically transferring incoming calls. In one embodiment, the method functions by the modules in FIG. 2 in the following manner.

In block S701, all the telephone devices are connected to the server, and update their usage information to the server, and the server sets rules for answering for all the telephone devices. When a telephone device is first connected to the server, the communication module 105 sends the registration information to the register module 101, and when and after the telephone device makes a call, the communication module 105 sends the usage information to the register module 101. The registration information comprises the phone number of the mobile phone 201, and the usage information can include the time of call and the call duration.

In block S703, the server sends the rules for answering and usage information to all the telephone devices. The register module 101 receives the usage information sent by the communication module 105, and sends the usage information and the rules for answering to all the telephone devices.

In block S705, all the telephone devices calculate a call transfer sequence according to the rules for answering and usage information. The sequence module 103 selects the “connected” telephone devices, sorts them in sequence according to their last call time, and sets the telephone device having the most recent call in first place, wherein the device which has been given first place has the highest priority in the sequence. On the basis of the rules for answering, combined with the sequence according to the usage information, the sequence module 103 can calculate the transfer sequence at different times, and the sequence module 103 updates the transfer sequence in real time based on the usage information.

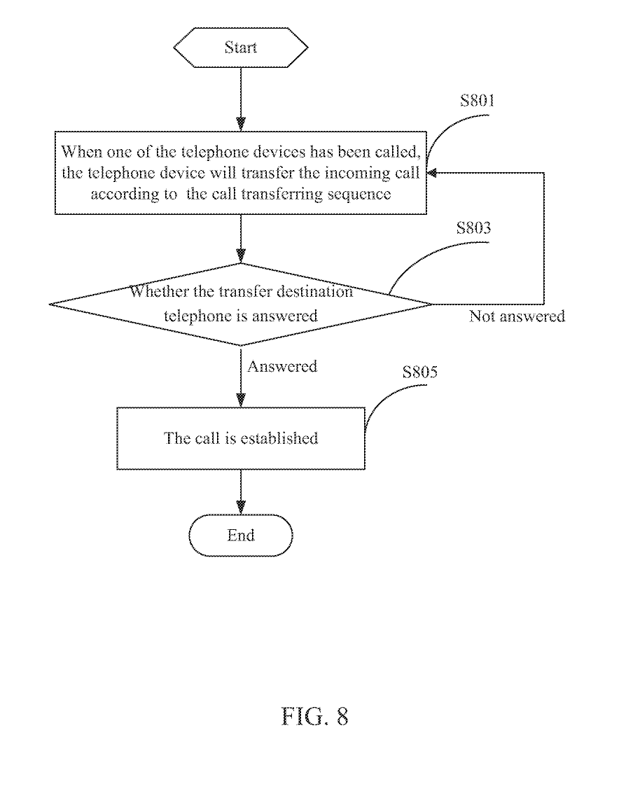

FIG. 8 is a flowchart illustrating one embodiment of the transferring of an incoming call.

In block S801, when one of the telephone devices has been called, the telephone device will transfer the incoming call based on the call transfer sequence. The transfer module 107 transfers the incoming call based on the call transfer sequence.

In block S803, the telephone device to which the call has been transferred determines whether the current destination telephone answers within a certain time. If the current destination telephone answers, go to block S805. If the current destination telephone does not answer the call in a certain time, repeat the step of block S803, where telephone device transfers the incoming call to the next telephone device based on the call transfer sequence. If none of the telephone devices answer, the telephone device can return a voice signal to the caller, such as “the user is busy, please dial again later”, and the telephone device can also record the caller's telephone number.

In block S805, when the current destination telephone answers, the call is established, and the flow of transferring calls is finished.

The telephone devices and the method for automatically transferring an incoming call can transfer an incoming call according to the transfer sequence.

What is claimed is:

1. A telephone device, transferring incoming calls to a plurality of other telephone devices via a server, the server communicating with the plurality of other telephone devices, the telephone device comprising:
at least one processor;
a storage system; and
one or more programs that are stored in the storage system and executed by the at least one processor, the one or more programs including instructions for:
receiving answer rules and usage information of the telephone device and the plurality of other telephone devices from the server;
sequencing the plurality of other telephone devices for call forwarding according to the answer rules and the usage information; and
transferring an incoming call to the plurality of other telephone devices according to the sequencing.

2. The telephone device as claimed in claim 1, wherein the one or more programs further including instructions for updating the usage information of the telephone device to the server after the telephone device has made a call, and the usage information comprises a beginning time and a duration of the call.

3. The telephone device as claimed in claim 1, wherein the sequencing the plurality of other telephone devices comprises: setting the first one of the plurality of other telephone devices which makes calls most recently in a preset period of time.

4. The telephone device as claimed in claim 1, wherein the transferring the incoming call comprises: transferring the incoming call to a next one of the plurality of other telephone devices upon condition that the first one telephone device fails to answer the incoming call within a predetermined time.

5. A method for transferring incoming calls, applied in a telephone device communicated with a server, the server communicating with a plurality of other telephone devices, the method comprising:
receiving answer rules and usage information of the telephone device and the plurality of other telephone devices from the server;
sequencing the plurality of other telephone devices for call forwarding according to the answer rules and usage information; and
transferring an incoming call to a first one of the plurality of other telephone devices according to a sequencing result.

6. The method as claimed in claim 5, further comprising: updating the usage information of the telephone device to the server after the telephone device having made a call, and the usage information comprises a beginning time and a duration of the call.

7. The method as claimed in claim 5, wherein calculating a call transferring sequence according to the answer rules and usage information further comprises: setting the first one of the plurality of other telephone devices which makes calls most recently in a preset period of time.

8. The method as claimed in claim 5, wherein transferring an incoming call according to the sequence of the other telephone devices further comprises: transferring the call to a next one of the sequence of the other telephone devices upon condition that the first one telephone device fails to answer the incoming call within a certain time.

9. A method for transferring an incoming telephone call comprising:
establishing, at a server, answer rules of a plurality of telephone devices;
receiving, at the server, usage information of the plurality of telephone devices;
sequencing, at the server, the plurality of telephone devices for call forwarding according to the answer rules and the usage information; and
sending, from the server, the sequence of the telephone devices to the plurality of telephone devices.

10. The method as claimed in claim 9, wherein the answer rules refers to different using priorities of the plurality of the telephone devices in different time periods, and the usage priorities comprises a beginning time and a duration of the call the plurality of the telephone devices having made.

11. The method as claimed in claim 9, wherein sequencing the plurality of telephone devices for call forwarding according to the answer rules and the usage information further comprises: setting a first one of the plurality of other telephone devices which makes calls most recently in a preset period of time.
